(19) United States
(12) Patent Application Publication
(10) Pub. No.: US 2010/0186828 A1
(43) Pub. Date: Jul. 29, 2010

(54) AIR FLOW CONTROL VALVE

(75) Inventors: Toru MATSUZAKI, Tochigi (JP); Kazunari Nakaya, Tochigi (JP)

Correspondence Address: ARENT FOX LLP, 1050 CONNECTICUT AVENUE, N.W., SUITE 400, WASHINGTON, DC, 20036, US

(73) Assignee: YACHIYO INDUSTRY CO., LTD., Saitama (JP)

(21) Appl. No.: 12/697,130

(22) Filed: Jan. 29, 2010

(30) Foreign Application Priority Data
Jan. 29, 2009 (JP) 2009-018158

(51) Int. Cl. F16K 24/04

(52) U.S. Cl. 137/202

(57) ABSTRACT

An air flow control valve includes a housing arranged in a fuel tank and having a canister communication port in an upper portion of the housing; and a float valve body embedded in the housing and closing the communication port by the valve body along with a rise of fuel in the housing, where orifice holes and vents configured to communicate with an inside and outside of the housing are formed and where the vents are configured to be located below the orifice holes and above a fuel level in a full state of the tank, wherein, regarding the orifice holes and the vents, when the communication port is closed by the valve body, only the orifice holes are in an air flow state, and when the communication port is open in the full state, the orifice holes and the vents are in the air flow state.

### BACKGROUND OF THE INVENTION

1. Field of the Invention

The present invention relates to an air flow control valve with which a fuel tank is equipped.

2. Description of the Related Art

As conventional technologies of an air flow control valve with which a fuel tank of a vehicle is equipped, those can be cited that are described in Japanese Patent Nos. 3931291 and 3948194. Respective valves described in the both Patents are arranged in a fuel tank; comprise a housing (housing 4 and cylindrical body 3 in the Japanese Patent No. 3931291, and case upper portion 41 and case lower portion 42 in the Japanese Patent No. 3948194) having a canister communication port in an upper portion of the fuel tank, and a float valve body (float valve 5 in the Japanese Patent No. 3931291 and float 46 in the Japanese Patent No. 3948194) for closing the communication port along with a rise of fuel in the housing; and in the housing is formed an orifice hole (communication port 44 and through-hole 32 in the Japanese Patent No. 3931291, and orifice 41k in the Japanese Patent No. 3948194) for communicating with an inside and outside of the housing.

General actions of the valves described in the both Patents will be described. If a liquid level of fuel occludes a lower end opening of the housing in fuel supply, a pressure in the fuel tank rises by a flow passage to an outside of the fuel tank being blocked, and the float valve body closes the canister communication port by the fuel rising in the housing. By the canister communication port being closed, the pressure in the fuel tank further rises, the fuel rises in a filler tube, and a first auto-stop in the fuel supply works when the liquid level of the fuel reaches a sensor of a fuel supply nozzle. Then by a part of vapors in the fuel tank passing through the orifice hole and gradually flowing in the housing, an air pressure difference between the inside and outside of the housing becomes small, the liquid level of the fuel in the housing lowers, and the float valve body lowers and the canister communication port opens. At this time, the air pressure difference between the inside and outside of the housing gradually becomes small through the orifice hole, and thereby a time from the auto-stop to reopening the float valve body can be taken to be long; therefore, even if additional fuel supply is performed therebetween, it is possible to prevent fuel oversupply. Then the canister communication port opens and the inside of the fuel tank communicates with an atmosphere side, and thereby the liquid level of the fuel again lowers as far as the lower end opening of the housing.

According to the respective valves described in the Japanese Patent Nos. 3931291 and 3948194, because the lower end opening of the housing is occluded by fuel in a full state of a fuel tank, the valves have a structure that the inside of the fuel tank and the canister communication port are communicated through the orifice hole only. However, if a generation amount of vapors in the fuel tank increases due to such a high temperature environment and the like as a summer season, there are some cases that only a small orifice hole cannot speedily release the vapors to a canister communication port side. There is a possibility in these cases that fuel rises in the housing along with a pressure rise in the housing, the float valve body is actuated and closes the canister communication port, and a flow outlet to an outside of the fuel tank is completely blocked. Conventionally, considering such a rise amount of a liquid level, although a housing height is set to be large, there are some cases that the housing height cannot be made large because flattening a fuel tank is recently required.

A method of escaping vapors in a housing in a full state of a fuel tank by setting an orifice hole to be large can be considered; however, in this case, because an air pressure difference between the inside and outside of the housing is soon reduced in additional fuel supply, a lowering speed of the liquid level in the housing becomes fast and the additional fuel supply is made possible soon. Furthermore, if the orifice hole is made large, a rising speed of the liquid level in the housing becomes slow and a valve closing actuation of the float valve body is delayed; therefore, finally resulting in fuel oversupply, there is a possibility that it is not possible to adequately detect a full tank position of the fuel tank.

The present invention is created in order to solve such problems, and is directed to provide an air flow control valve that can compatibly achieve a vapor elimination function and a fuel-oversupply prevention function in a full state of a fuel tank.

### SUMMARY OF THE INVENTION

The present invention is an air flow control valve comprising: a housing configured to be arranged in a fuel tank and having a canister communication port in an upper portion of the housing; and a float valve body configured to be embedded in the housing and to close the communication port along with a rise of fuel in the housing, wherein orifice holes configured to communicate with an inside and outside of the housing are formed therein, wherein vents configured to communicate with the inside and outside of the housing and to be located below the orifice holes and above a fuel level in the fuel tank in a full state thereof are formed in the housing, and wherein, with respect to the orifice holes and the vents, when the communication port is completely closed by the float valve body, only the orifice holes are in an air flow state, and when the communication port is open in the full state of the fuel tank, the orifice holes and the vents are configured to be in the air flow state.

According to the invention, the orifice holes and the vents are in an air flow state when the canister communication port is open in the full state of the fuel tank, and thereby, it is possible to release vaporized fuel (vapors) generated in the full state of the fuel tank in a high temperature environment and the like such as a summer season from the vents in addition to the orifice holes to an outside of the fuel tank and to prevent a pressure of the tank from rising. Accordingly, it is possible to suppress the fuel level in the housing from rising, to set by that amount a height of the housing to be low, and to easily take action to flatten the tank.

Then because it is configured that only the orifice holes are in an air flow state when the canister communication port is closed by the float valve body, an air pressure difference between the inside and outside of the housing is slowly reduced in additional fuel supply. That is, while at least the fuel level is lowered more than the vents and those are in a state of an air flow, a lowering speed of the fuel level in the housing in a transition from a state of an auto-stop to that of next additional fuel supply being available is equivalent to an air flow state only through the orifice holes, the additional fuel supply is not made possible soon, and fuel oversupply is prevented.

Furthermore, the invention is easily applicable to an air flow control valve where a lower end opening is formed at a lower end of a housing, and where a fuel level in a fuel tank of its full state is set at a height position of the lower end opening.

According to the present invention, it is possible to suppress a height size of a housing of an air flow control valve and to easily take action to flatten a fuel tank.

### BRIEF DESCRIPTION OF THE DRAWINGS

FIG. 1 is a side section drawing of an air flow control valve relating to the present invention.

FIGS. 2A, 2B, and 2C are action illustration drawings of the air flow control valve relating to the invention.

FIG. 3 is a side section drawing of a modification example of the air flow control valve relating to the invention where vents are provided on an upper housing side.

### BEST MODE(S) FOR CARRYING OUT THE INVENTION

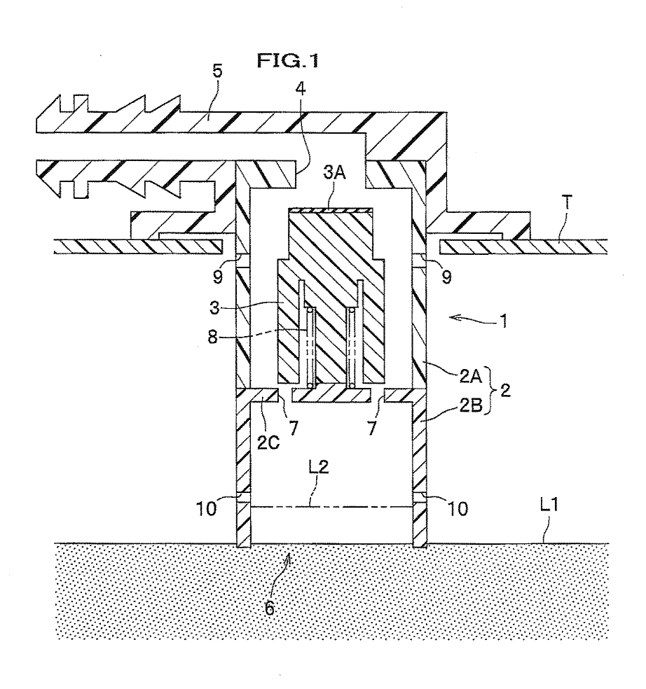

Here will be described the present invention with reference to drawings. FIG. 1 is a side section drawing of an air flow control valve 1 relating to the present invention.

The air flow control valve 1 relating to the invention comprises a housing 2 arranged in a fuel tank T and having a canister communication port 4 in an upper portion of the housing 2 and a float valve body 3 configured to be embedded in the housing 2 and to close the port 4 along with a rise of fuel in the housing 2.

A connection port member 5 is attached to an upper surface of the fuel tank T by heat welding and the like. The connection port member 5 is a member configured to be connected to a canister not shown through a connecting hose (not shown); the housing 2 whose upper circumference is integrally formed with the connection port member 5 is located at an upper inside of the fuel tank T. The connection port member 5 and the housing 2 may be configured, for example, with two-color molding, or may also be an integrally molded body of a same material.

The housing 2 is a housing member presenting a cylindrical shape, and in FIG. 1 is shown a case that the housing 2 is dividedly configured into an upper housing 2A and a lower housing 2B whose respective outer diameters and inner diameters are approximately same. The upper housing 2A and the lower housing 2B may be configured as the integral housing 2 by a well-known engaging means, for example, such as a claw engagement system, or configured with two-color molding, or configured with an integrally molded body of a same material.

At an upper face middle of the upper housing 2A is formed the canister communication port 4; at a lower end of the lower housing 2B is formed a lower end 6. Furthermore, an upper portion of the lower housing 2B is formed to be like a circular lid, and configures a partition 2C for partitioning each inner space of the upper housing 2A and the lower housing 2B. In the partition 2C are formed a plurality of communication ports 7 for communicating with each inner space of the upper housing 2A and the lower housing 2B.

Inside the upper housing 2A are housed the float valve body 3 and a compressed coil spring 8 configured to be provided between the body 3 and the partition 2C and to assist the rise of the body 3. To an upper portion of the float valve body 3 is attached a sheet 3A for occluding the canister communication port 4 by being made in face contact with a circumferential edge of the port 4.

In a circumference wall of the upper housing 2A are bored orifice holes 9 communicating with the inside and outside of the housing 2A. Formed positions of the orifice holes 9 are around vicinities of upper portion of the fuel tank T. In the present embodiment, although the orifice holes 9 are bored in pair at positions opposite to 180 degrees with each other across an axis of the upper housing 2A, a number of the port 9 may also be one or not less than three.

In the housing 2 are bored vents 10, which are located lower than the orifice holes 9 and upper than a fuel level Li in the fuel tank T of its full state. In FIG. 1 is shown a case that the vents 10 are bored in a circumference wall of the lower housing 2B, specifically in pair at positions opposite to 180 degrees with each other across an axis of the housing 2B. However, a number of the vent 10 is not limited thereto and may also be one or not less than three.

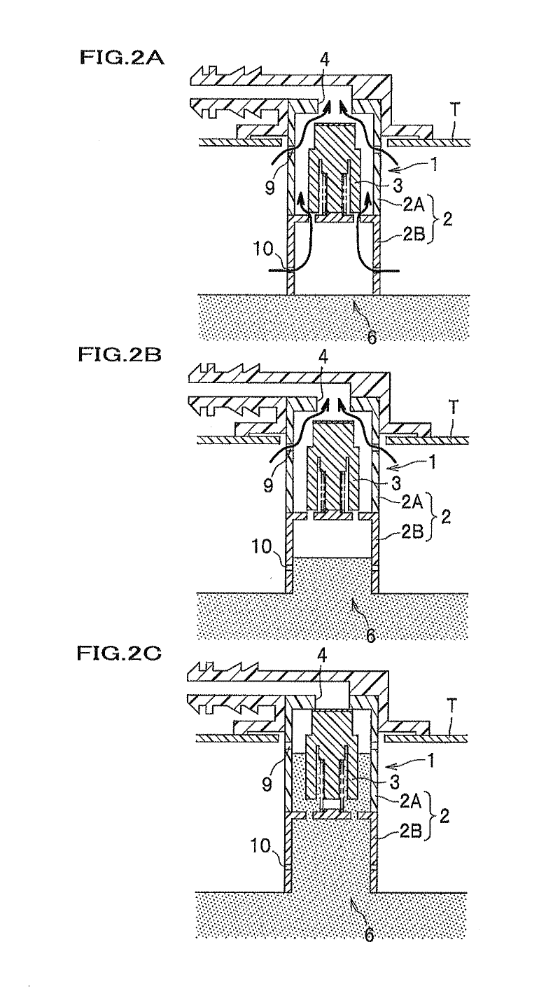

Actions of the air flow control valve 1 thus configured will be described. FIGS. 2A, 2B, and 2C are action illustration drawings of the air flow control valve 1. When fuel is supplied in the fuel tank T, and a fuel level reaches the lower end of the housing 2 as shown in FIG. 2A and occludes a lower end opening 6, a pressure in the tank T rises by a flow passage of vapors to an outside of the tank T being blocked, and the fuel rises in the housing 2 as shown in FIG. 2B. Because the vents 10 are configured with a circular hole of a small diameter and the like, they are occluded in a rising process of the fuel.

Then, as shown in FIG. 2C, the float valve body 3 closes the canister communication port 4 in a stage of the fuel level in the housing 2 having reached around the most risen position. The orifice holes 9 are always in an air flow state without being occluded by the fuel. By the canister communication port 4 being closed, the pressure in the fuel tank T further rises, the fuel rises in a filler tube not shown, and a first auto-stop in fuel supply works when a fuel level in the filler tube reaches a sensor of a fuel supply nozzle (not shown).

After the first auto-stop of the fuel supply works, a part of vapors in the fuel tank T passing through the orifice holes 9 and gradually flowing in the housing 2 (upper housing 2A), thereby an air pressure difference between the inside and outside of the housing 2 becomes small, and thus the fuel level in the housing 2 lowers, that is, the float valve body 3 lowers, and the canister communication port 4 opens. By the canister communication port 4 being opened and the inside of the fuel tank T being communicated with the canister, that is, communicated with an atmosphere side, the fuel level in the tank T returns to the state of FIG. 2A, and the fuel level in the filler tube also lowers; thereby it becomes possible to supply a small amount of additional fuel. An operation of the air flow control valve 1 in additional fuel supply is the same operation as mentioned above, and normally, the fuel of the fuel tank T is in a full state at a timing when this additional fuel supply is repeated several times. The fuel level L1 in the fuel tank T in its full state is at a height position of the lower end opening 6 as shown in FIG. 1, strictly speaking, at a height position near the lower end opening 6 in a state of the opening 6 being occluded.

As understood from the matters mentioned above, according to the air flow control valve 1 of the invention, with respect to the orifice holes 9 and the vents 10, when the canister communication port 4 is completely closed by the float valve body 3 as shown in FIG. 2C, only the holes 9 are in an air flow state; whereas, when the canister communication port 4 is open, that is, as shown in FIG. 1, when the fuel tank in its full state is at the fuel level L1 and the port 4 is open, the orifice holes 9 and the vents 10 are configured to be in an air flow state; and in accordance with this configuration, the following effects are brought.

Firstly describing a case of not having the vents 10, when the fuel tank T is full as shown in FIG. 1, and if a generation amount of vapors in the tank T is much due to a high temperature environment and the like such as a summer season, the lower end opening 6 is in a state of being occluded; it is difficult to speedily release the vapors to a canister communication port 4 side only through the small orifice holes 9. Then the fuel rises in the housing 2 due to a pressure rise in the fuel tank T, the float valve body 3 is actuated and occludes the canister communication port 4, and there is a possibility that a flow outlet of the vapors to an outside of the tank T is completely blocked. Although there is no problem if a height of the housing 2 (lower housing 2B) is set with considering a rise amount of the fuel level in the housing 2, there is a case where the height of the housing 2 (lower housing 2B) does not afford to be high when the fuel tank T is required to be flat.

Furthermore, when attempting to release vapors in the fuel tank T of its full state by setting the orifice holes 9 large, an air flow resistance of the holes 9 is small; therefore, an air pressure difference between the inside and outside of the housing 2 is reduced in additional fuel supply. That is, there is a problem that: a lowering speed of a fuel level in the housing 2 is fast in a transition from a state of an auto-stop having worked in FIG. 2C to that of next additional fuel supply being available; and the additional fuel supply becomes possible soon. Furthermore, when the air flow resistance of the orifice holes 9 is small, the rising speed of a fuel level in the housing 2 is slow, a valve-closing-actuation response of the float valve body 3 is dull, finally resulting in fuel oversupply; therefore, there is a possibility that it is not possible to adequately detect a full position of the fuel tank T.

On the contrary, according to the invention, the orifice holes 9 and the vents 10 are made in an air flow state when the canister communication port 4 is open in the full state of the fuel tank T, and thereby, it is possible to release the vapors generated in the full state in a high temperature environment and the like such as a summer season from the vents 10 in addition to the orifice holes 9 to an outside of the fuel tank T and to prevent the pressure of the tank T from rising. Accordingly, it is possible to suppress the fuel level from rising in the housing 2, to set by that amount the height of the housing 2 (lower housing 2B) to be low, and to easily take action to flatten the tank T.

Then, according to the invention, because it is configured that only the orifice holes 9 of a small diameter similar to conventional one are in an air flow state when the canister communication port 4 is closed by the float valve body 3 in an auto-stop state in fuel supply, an air pressure difference between the inside and outside of the housing 2 is slowly reduced in additional fuel supply. That is, while at least the fuel level is lowered more than the vents 10 and those are in a state of an air flow, a lowering speed of a fuel level in the housing 2 in a transition from a state of an auto-stop having worked in FIG. 2C to that of next additional fuel supply being available is equivalent to an air flow state only through the orifice holes, the additional fuel supply is not made possible soon, and fuel oversupply is prevented.

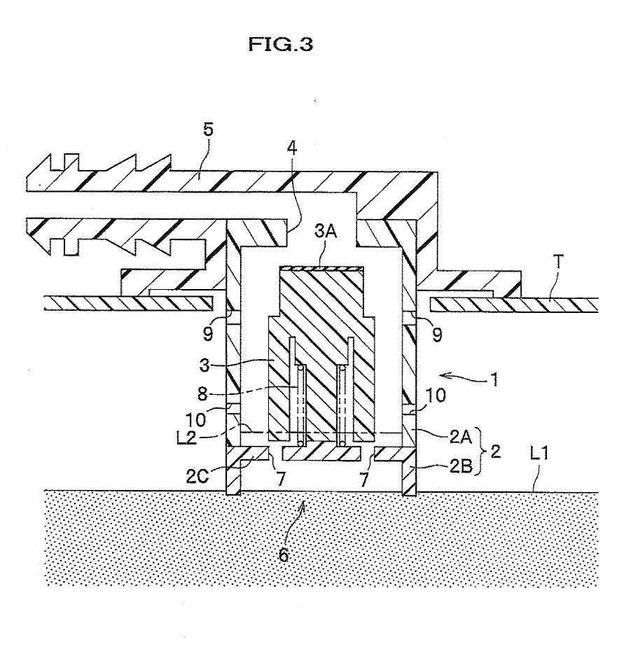

In addition, although a slit 42b is shown in FIG. 3 of the Japanese Patent No. 3948194, the slit 42b is a hole set to be submerged in a full state of a fuel tank and is different in function from the vents 10 of the invention.

Thus the best mode of the present invention has been described. The shape, size, and number of the vents 10 are appropriately set, and bore positions may be located below the orifice holes 9 and above the fuel level L1 in the fuel tank T in its full state. Specifically, when a fuel level rises in the housing 2 in vapor generation, the positions of the vents 10 are above its rising fuel level L2 (shown by a virtual line in FIG. 1). Because the height of the rising fuel level L2 is derived from a generation amount of vapors in an assumed high temperature environment, the vents 10 are provided above the level L2. However, because the valve-closing-actuation response of the float valve body 3 is dull if distances from the rising fuel level L2 above the vents 10 are too wide, positions slightly upper than the assumed rising fuel level L2 are desirable. Accordingly, for example, as shown in FIG. 3, when the length of the lower housing 2B is short and the rising fuel level L2 is located at an upper housing 2A side, the upper housing 2A is provided with the vents 10 at positions slightly upper than the level L2.

What is claimed is:

1. An air flow control valve comprising;
a housing configured to be arranged in a fuel tank and having a canister communication port in an upper portion of the housing; and
a float valve body configured to be embedded in the housing and to close the canister communication port along with a rise of fuel in the housing,
wherein orifice holes configured to communicate with an inside and outside of the housing are formed therein,
wherein vents configured to communicate with the inside and outside of the housing and to be located below the orifice holes and above a fuel level in the fuel tank in a full state thereof are formed in the housing, and
wherein, with respect to the orifice holes and the vents, when the canister communication port is completely closed by the float valve body, only the orifice holes are in an air flow state, and when the communication port is open in the full state, the orifice holes and the vents are configured to be in the air flow state.

2. The air flow control valve according to claim 1, wherein a lower end opening is formed at a lower end of the housing, arid the fuel level in the fuel tank of the full state is set at a height position of the lower end opening.

3. The air flow control valve according to claim 1, wherein the vents are a small circular hole having a size configured to be occluded by the fuel rising in the housing in fuel supply.

4. The air flow control valve according to claim 2, wherein the vents are a small circular hole having a size occluded by the fuel rising in the housing in fuel supply.

5. The air flow control valve according to claim 1, wherein the vents are formed at positions upper than a height of a rising fuel level derived from a generation amount of vapors in a high temperature environment assumed in advance in no fuel supply.

6. The air flow control valve according to claim 2, wherein the vents are formed at positions upper than a height of a rising fuel level derived from a generation amount of vapors in a high temperature environment assumed in advance in no fuel supply.

7. The air flow control valve according to claim 3, wherein the vents are formed at positions upper than a height of a rising fuel level derived from a to generation amount of vapors in a high temperature environment assumed in advance in no fuel supply.

8. The air flow control valve according to claim 4, wherein the vents are formed at positions upper than a height of a rising fuel level derived from a generation amount of vapors in a high temperature environment assumed in advance in no fuel supply.
